(19) United States
(12) Patent Application Publication
(10) Pub. No.: US 2025/0371878 A1
(43) Pub. Date: Dec. 4, 2025

(54) Computer-Vision System for Item and Container Identification for Sorting Error Detection

(71) Applicant: Maplebear Inc., San Francisco, CA (US)

(72) Inventors: Benjamin Knight, Oakland, CA (US); Rebecca Riso, Croton-On-Hudson, NY (US); Christopher Billman, Chicago, IL (US); Radhika Anand, Redwood City, CA (US); Adam Vanderpool, Fort Worth, TX (US); Sai Kannan Sampath, Berkeley, CA (US); Zirui Zhong, San Jose, CA (US); Kenneth Jason Sanchez, Orange, CA (US)

(21) Appl. No.: 18/677,481

(22) Filed: May 29, 2024

(51) Int. Cl. G06V 20/50; G06V 10/25; G06V 10/82

(52) U.S. Cl. CPC G06V 20/50; G06V 10/25; G06V 10/82

(57) ABSTRACT

An online system uses a computer-vision item identification model to identify items and physical containers storing those items to detect sorting errors of the physical containers. The online system receives a first image from a client device that depicts a set of physical containers that contain items for a batch of orders that the online system has received. The online system identifies items in those physical containers by applying a contained-item identification model to the first image. The online system uses the output of this model to determine which visible items are in each physical container and uses that information plus order data for the batch of orders to determine which physical containers are associated with each order. The online system compares this first image to a subsequently received image to determine whether the correct physical containers were delivered by the user.

### BACKGROUND

Computer-vision machine-learning models are machine-learning models that are trained to identify objects that are depicted in images. These models may use complex neural networks, such as convolutional neural networks, to extract features from images to generate predictions of what objects are depicted in the images. Computing systems may use these models to monitor how users are interacting with items and to enable certain features. However, these models are generally trained to identify items based on images that fully depict items and generally tend to underperform when items are partially obscured. Thus, computing systems that use computer-vision machine-learning models to identify items are generally limited to doing so based on images that fully or mostly depict those items.

These technical limitations to computer-vision machine-learning models hamper their efficacy in certain contexts. For example, items may be stored in physical containers, such as boxes or bags, that occlude visibility of the items from a camera that is capturing images of those items. These occlusions mean that computing systems that use computer-vision machine-learning models have limited ability to monitor how users are interacting with items because some of those items may be unviewable by the system. This can cause problems for computing systems in certain contexts. For example, computing systems that monitor how items are sorted by users into physical containers are generally limited to identifying items that are visible, meaning that many items that are stored by a physical container can be incorrectly sorted without correction by the computing system.

### SUMMARY

In accordance with one or more aspects of the disclosure, an online system uses a computer-vision item identification model to identify items and physical containers storing those items to detect sorting errors of the physical containers. The online system receives a first image from a client device that depicts a set of physical containers that contain items for a batch of orders that the online system has received. The online system identifies items in those physical containers by applying a contained-item identification model to the first image. The contained-item identification model is a machine-learning model that identifies physical containers and visible items in the image. The online system uses the output of this model to determine which visible items are in each physical container and uses that information plus order data for the batch of orders to determine which physical containers are associated with each order (e.g., contain items for the order).

The online system compares this first image to a subsequently received image to determine whether the correct physical containers were delivered by the user. Specifically, the online system receives a second image that only depicts a subset of the physical containers and visible items. The online system applies the contained-item identification model to the second image to identify the containers and visible items in that image. The online system may then compare the identified containers and visible items with the ones identified for a particular order from the first image to determine whether the containers and visible items in the second image match with those identified in the first image. If there is a mismatch (e.g., a container is missing, an extra container is visible in the second image, or the wrong container is in the second image), the online system alerts a user that a sorting error occurred and instructs the user to correct the sorting error.

By using visible items contained in physical containers as identifiers for the physical containers themselves, the online system can thereby ensure that the correct physical containers are delivered for the correct orders while overcoming the technical limitations of conventional computer-vision machine-learning models described above.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart for a method of detecting sorting errors using a computer-vision model, in accordance with some embodiments

FIG. 4 illustrates an example first image depicting a set of physical containers and visible contained items, in accordance with some embodiments.

FIG. 5 illustrates an example container-item pair generated based on a set of visible contained items and their corresponding container, in accordance with some embodiments.

FIG. 6 illustrates example sorting errors detected by an online system, in accordance with some embodiments.

### DETAILED DESCRIPTION

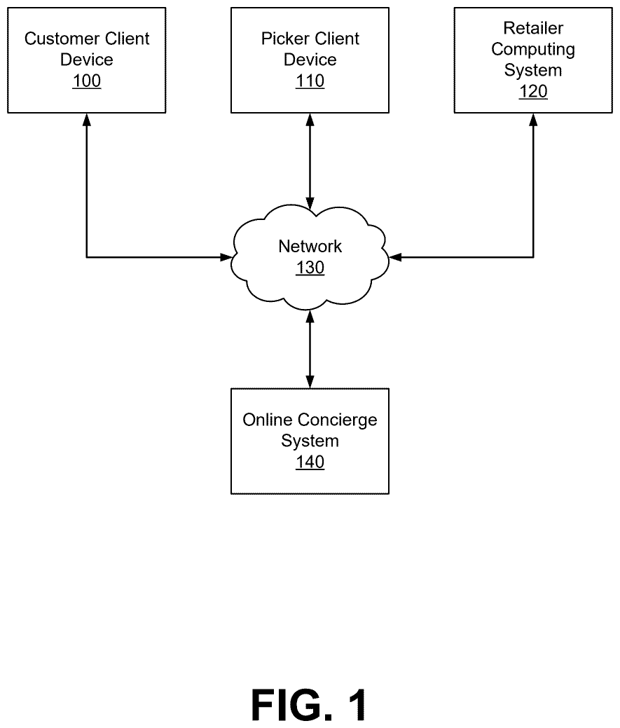

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item”, as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order.

Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from a user client device 100 through the network 130. The online concierge system 140 selects a picker to service the user's order and transmits the order to a picker client device 110 associated with the picker. The picker collects the ordered items from a retailer location and delivers the ordered items to the user. The online concierge system 140 may charge a user for the order and provide portions of the payment from the user to the picker and the retailer.

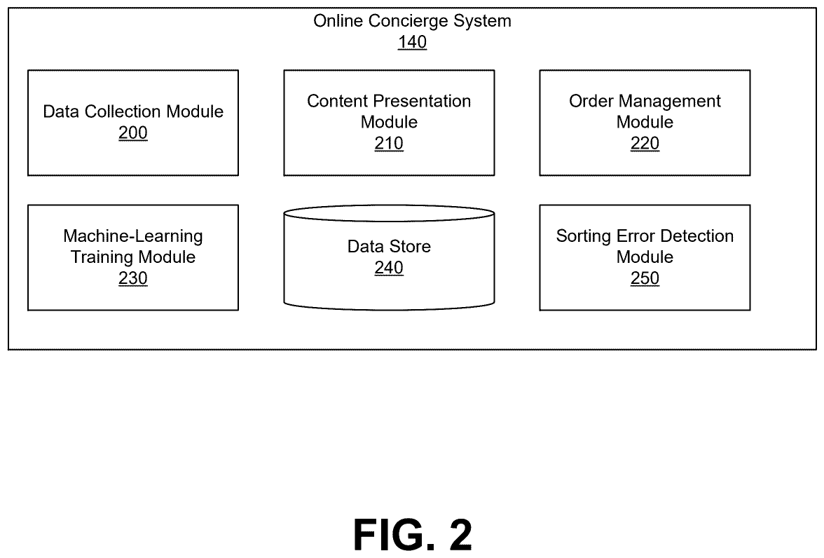

As an example, the online concierge system 140 may allow a user to order groceries from a grocery store retailer. The user's order may specify which groceries they want delivered from the grocery store and the quantities of each of the groceries. The user's client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a data store 240, and a sorting error detection module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a user rating for the picker, which retailers the picker has collected items at, or the picker's previous shopping history. Additionally, the picker data may include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The sorting error detection module 250 uses a computer-vision machine-learning model to detect sorting errors of physical containers to orders in a batch of orders. The sorting error detection module 250 uses an initial image from a picker to determine which items in physical containers are visible from outside the container. The online system uses these visible items as pseudo-identifiers for each container and associates each container with its corresponding order in a batch. When the picker delivers the containers for an order at the order's delivery location, the picker takes another picture of the delivered containers. The online system uses the visible items to identify the containers that were delivered at the delivery location and compares the delivered containers to the containers that should be delivered for that order. The online system can thereby determine whether a picker accidentally delivered the wrong subset of containers for a batch of orders to a particular order location.

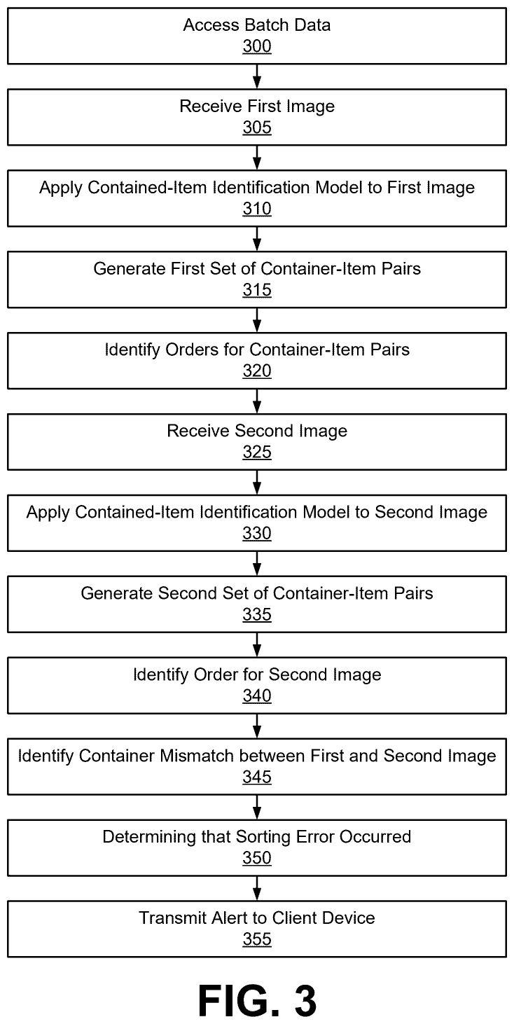

FIG. 3 is a flowchart for a method of detecting sorting errors using a computer-vision model, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online system accesses 300 batch data describing a batch of orders. A batch is a set of orders that are assigned to a user to collect from a retailer. Each order in the set of orders has a set of items that were ordered by another user of the online system. The online system may batch orders together based on order data describing the orders so that the orders are more efficiently collected by a picker at a retailer.

The online system receives 305 a first image from a client device associated with a picker. The first image depicts physical containers that contain items that were collected by the picker. For example, the first image may be an image of the physical containers after the picker has collected items at a retailer, stored the items in the containers, and placed the containers in a vehicle that the picker will use to deliver the items. The physical containers may be paper or plastic bags, boxes, baskets, carts, or backpacks.

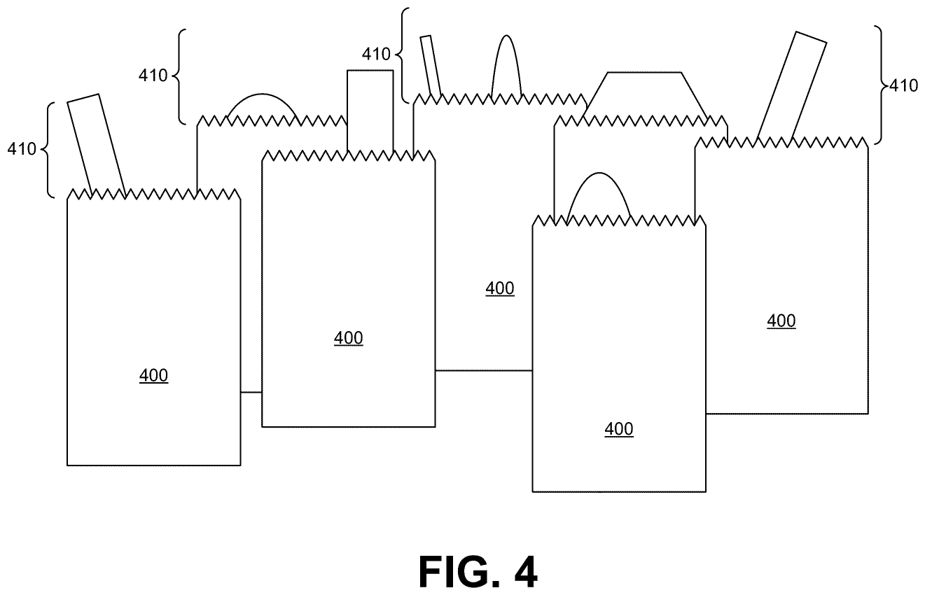

The first image also depicts items that are contained in each physical container. In some cases, the first image depicts all of the items that were collected by the picker user for the batch of orders. For example, the containers may be translucent or transparent, or may have openings that allow someone to view the contents (e.g., made of a mesh or other perforated material). More commonly though, only a subset of the collected items are visible in the image. For example, if the containers are opaque paper bags, the first image may only depict items that are partially above the top of the paper bags and therefore visible in the first image. Items which are depicted in an image and are visible while being stored in physical containers may be referred to as “visible contained items.” FIG. 4 illustrates an example first image depicting a set of physical containers 400 and visible contained items 410, in accordance with some embodiments. While FIG. 4 depicts an image captured from a side-on perspective of the physical containers, images of the physical containers may be taken from any view, such as top-down, side-on, or perspective. In some cases, the online system instructs a user to capture an image using a given perspective (e.g., top-down) to improve the efficacy of identifying items in the image.

The online system applies 310 a contained-item identification model to the first image. A contained-item identification model is a machine-learning computer vision model (e.g., a neural network) that is trained to identify containers that are depicted in an image and visible contained items in those containers. The contained-item identification model takes an image as an input. The output may include bounding boxes indicating where containers are located in the image, identifiers for visible contained items that are depicted in the image, or bounding boxes for where visible contained items are in the image. In some embodiments, the contained-item identification model is a multi-modal large language model (LLM).

The online system generates 315 a first set of container-item pairs based on the output of the contained-item identification model when the model is applied to the first image. A container-item pair associates a set of visible contained items that were identified by the model with one of the physical containers depicted in the image. For example, where the physical containers are paper bags, the items associated with a bag in a container-item pair may be items that are visible above the top of the bag. The online system generates a container-item pair for each container identified by the model, and may thereby assign each of the visible contained items to a physical container in the image. The online system may generate the container-item pairs based on the locations of the visible contained items in the image, the locations of the physical containers in the image, or the order data for orders in the batch. In some embodiments, the online system applies a machine-learning model to the first image and the output of the contained-item identification model to generate the container-item pairs. For example, the machine-learning model may be trained to associate visible contained items with a physical container, and the online system may use these associations to generate the container-item pairs.

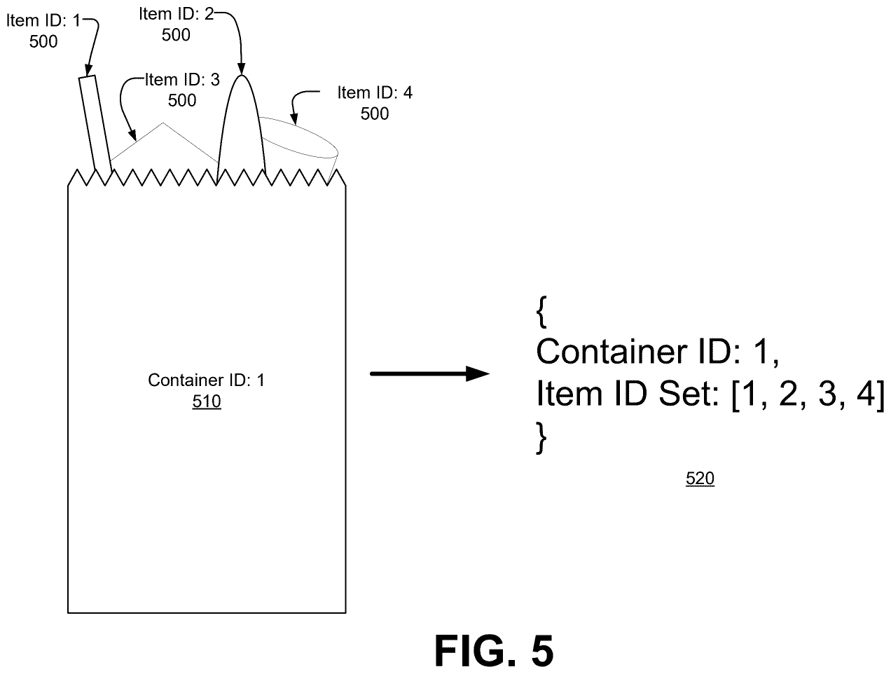

FIG. 5 illustrates an example container-item pair 520 generated based on a set of visible contained items 500 and their corresponding container 510, in accordance with some embodiments. The online system uses item identifiers to identify the items and creates a set of visible contained items corresponding to the physical container. The container-item pair includes the set of item identifiers and an identifier for the container.

The online system identifies 320 an order in the batch for each of the container item pairs for which a container likely contains items. For example, if only one order in a batch includes an apple and a container-item pair includes an apple in its set of visible contained items, the online system may associate the physical container for that pair with the order since no other order in the batch would have an apple. The online system may apply a set of heuristics or rules to the order data and the set of container-item pairs to determine which order each of the container-item pairs corresponds to. For example, the online system may only associate a physical container with an order if the corresponding visible contained items for the container are items in the order. In some embodiments, the online system applies techniques for solving constraint satisfaction problems to identify orders in the batch for each of the container-item pairs. For example, the online system may iteratively assign container-item pairs to orders until a contradiction occurs (e.g., an order gets no containers or an order is assigned a container with an item that was not part of the order) and then backtracks the iteration based on the contradiction.

The online system receives 325 a second image from the picker's client device. The second image depicts a subset of the physical containers depicted in the first image, and similarly depicts a subset of the visible contained items. For example, the second image may be an image depicting physical containers that have been placed by the picker at a delivery location for the order. To determine whether the physical containers that were delivered for the order are the correct physical containers, the online system applies 330 the contained-item identification model to the second image and generates 335 a second set of container-item pairs based on the output of the contained-item identification model. The online system may generate the second set of container-item pairs using a similar process to how the online system generates the first set of container-item pairs.

The online system identifies 340 an order associated with the second image. For example, the online system may receive an order identifier from the picker's client device that identifies the order. Alternatively, the online system may identify the order based on the second set of container-item pairs. For example, the online system may compare the second set of container-item pairs to the first set of container-item pairs and use the identified orders for the first set of container-item pairs to identify an order for the second set of container-item pairs.

The online system uses the identified order to identify 345 a container mismatch between the first image and the second image. Specifically, the online system may determine that a container depicted in the second image corresponds to a different order than the identified order. For example, the online system may compare the second set of container-item pairs to the container-item pairs that were associated with the identified order. If the second set of container-item pairs includes a container that was not associated with the identified order, the online system may determine that there is a mismatch between the first and second image. Similarly, if the second set of container-item pairs includes a container that is not associated with the identified order, the online system may identify the mismatch.

The online system determines 350 that a sorting error occurred based on the container mismatch and transmits 355 an alert to the picker's client device. The alert causes the client device to display instructions to the picker to correct the sorting error. For example, the alert may identify which container is missing from or should not have been included in the second image and may instruct the picker to correct the error by adding or removing the identified container. In some embodiments, the alert includes an altered version of the second image that indicates a container to remove.

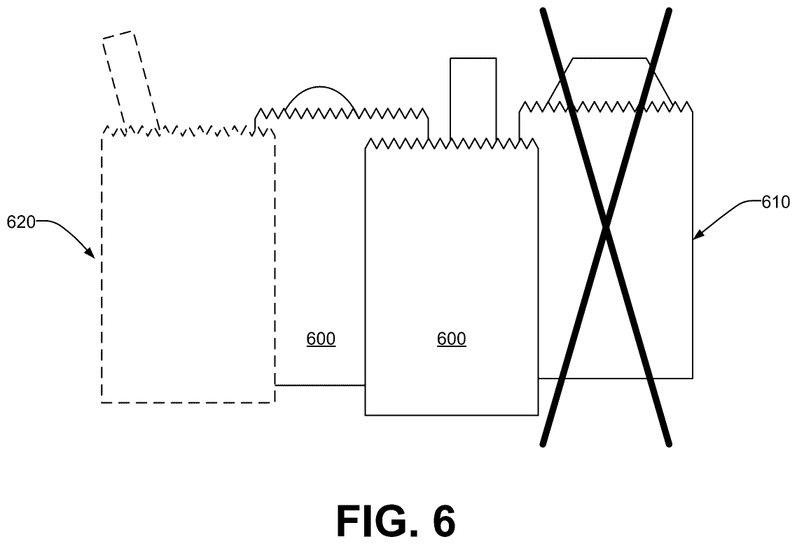

FIG. 6 illustrates example sorting errors detected by an online system, in accordance with some embodiments. As noted above, the online system identifies an order associated with the second image and identifies which containers correspond to that order. The online system compares those containers to the containers depicted in the second image. In FIG. 6, two containers 600 depicted in the second image correspond to the identified order. One container 610 does not and one container 620 is missing.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
accessing batch data describing a plurality of orders associated with a batch, wherein each order comprises a plurality of items;
receiving a first image from a client device, wherein the first image depicts a plurality of physical containers and a plurality of visible contained items;
applying a contained-item identification model to the first image to identify the plurality of physical containers and the plurality of visible contained items depicted in the first image, wherein the contained-item identification model is a machine-learning computer-vision model that is trained to identify containers and visible items that are contained by those containers;
generating a first set of container-item pairs, wherein each container-item pair comprises an identified container of the plurality of identified physical containers and a subset of the plurality of visible contained items, wherein the subset of visible contained items of a container-item pairs are items contained by the corresponding container that are visible in the first image;
identifying an order of the plurality of orders for each container-item pair of the set of container-item pairs based on the subset of the plurality of visible contained items associated with each container-item pair;
receiving a second image from the client device, wherein the second image depicts a subset of the plurality of physical containers and a subset of the plurality of visible contained items;
applying the contained-item identification model to the second image to identify the subset of the plurality of physical containers and the subset of the plurality of visible contained items depicted in the second image;
generating a second set of container-item pairs, wherein each of the second set of container-item pairs comprises an identified container of the subset of the physical containers of the second image and the visible contained items contained by the corresponding containers;
identifying an order of the plurality of orders associated with the second image;
identifying a container of the subset of the plurality of physical containers depicted in the second image that is not associated with the identified order of the plurality of orders;
identifying that a sorting error occurred based on the identified container; and
transmitting an alert to the client device, wherein the alert causes the client device to display an instruction to a user associated with the client device to correct the sorting error.

2. The method of claim 1, wherein the plurality of physical containers are at least one of paper bags, plastic bags, boxes, baskets, carts, or backpacks.

3. The method of claim 1, wherein the contained-item identification model comprises a convolutional neural network.

4. The method of claim 1, wherein the contained-item identification model comprises a multi-modal large language model.

5. The method of claim 1, wherein the contained-item identification model is trained to output at least one of bounding boxes indicating where physical containers are located in an image, identifiers for visible contained items depicted in an image, or bounding boxes for visible contained items depicted in an image.

6. The method of claim 1, wherein identifying an order for each container-item pair of the set of container-item pairs comprises:
applying a set of heuristics or a set of rules to the set of container-item pairs and the batch data.

7. The method of claim 1, wherein identifying an order for each container-item pair of the set of container-item pairs comprises:
applying a technique for solving a constraint satisfaction problem to the set of container-item pairs and the batch data.

8. The method of claim 1, wherein the batch data comprises order data for each order of the plurality of orders.

9. The method of claim 1, further comprising:
identifying a container associated with the identified order that is not depicted in the second image.

10. A non-transitory computer-readable medium storing instructions that, when executed by a processor of a computer system, cause the computer system to perform operations comprising:
accessing batch data describing a plurality of orders associated with a batch, wherein each order comprises a plurality of items;
receiving a first image from a client device, wherein the first image depicts a plurality of physical containers and a plurality of visible contained items;
applying a contained-item identification model to the first image to identify the plurality of physical containers and the plurality of visible contained items depicted in the first image, wherein the contained-item identification model is a machine-learning computer-vision model that is trained to identify containers and visible items that are contained by those containers;
generating a first set of container-item pairs, wherein each container-item pair comprises an identified container of the plurality of identified physical containers and a subset of the plurality of visible contained items, wherein the subset of visible contained items of a container-item pairs are items contained by the corresponding container that are visible in the first image;
identifying an order of the plurality of orders for each container-item pair of the set of container-item pairs based on the subset of the plurality of visible contained items associated with each container-item pair;
receiving a second image from the client device, wherein the second image depicts a subset of the plurality of physical containers and a subset of the plurality of visible contained items;
applying the contained-item identification model to the second image to identify the subset of the plurality of physical containers and the subset of the plurality of visible contained items depicted in the second image;
generating a second set of container-item pairs, wherein each of the second set of container-item pairs comprises an identified container of the subset of the physical containers of the second image and the visible contained items contained by the corresponding containers;
identifying an order of the plurality of orders associated with the second image;
identifying a container of the subset of the plurality of physical containers depicted in the second image that is not associated with the identified order of the plurality of orders;
identifying that a sorting error occurred based on the identified container; and
transmitting an alert to the client device, wherein the alert causes the client device to display an instruction to a user associated with the client device to correct the sorting error.

11. The computer-readable medium of claim 10, wherein the plurality of physical containers are at least one of paper bags, plastic bags, boxes, baskets, carts, or backpacks.

12. The computer-readable medium of claim 10, wherein the contained-item identification model comprises a convolutional neural network.

13. The computer-readable medium of claim 10, wherein the contained-item identification model comprises a multi-modal large language model.

14. The computer-readable medium of claim 10, wherein the contained-item identification model is trained to output at least one of bounding boxes indicating where physical containers are located in an image, identifiers for visible contained items depicted in an image, or bounding boxes for visible contained items depicted in an image.

15. The computer-readable medium of claim 10, wherein identifying an order for each container-item pair of the set of container-item pairs comprises:
applying a set of heuristics or a set of rules to the set of container-item pairs and the batch data.

16. The computer-readable medium of claim 10, wherein identifying an order for each container-item pair of the set of container-item pairs comprises:
applying a technique for solving a constraint satisfaction problem to the set of container-item pairs and the batch data.

17. The computer-readable medium of claim 10, wherein the batch data comprises order data for each order of the plurality of orders.

18. The computer-readable medium of claim 10, the operations further comprising:
identifying a container associated with the identified order that is not depicted in the second image.

19. A system comprising:
a processor; and
a non-transitory computer-readable medium storing instructions that, when executed by a processor of a computer system, cause the computer system to perform operations comprising:
accessing batch data describing a plurality of orders associated with a batch, wherein each order comprises a plurality of items;
receiving a first image from a client device, wherein the first image depicts a plurality of physical containers and a plurality of visible contained items;
applying a contained-item identification model to the first image to identify the plurality of physical containers and the plurality of visible contained items depicted in the first image, wherein the contained-item identification model is a machine-learning computer-vision model that is trained to identify containers and visible items that are contained by those containers;
generating a first set of container-item pairs, wherein each container-item pair comprises an identified container of the plurality of identified physical containers and a subset of the plurality of visible contained items, wherein the subset of visible contained items of a container-item pairs are items contained by the corresponding container that are visible in the first image;
identifying an order of the plurality of orders for each container-item pair of the set of container-item pairs based on the subset of the plurality of visible contained items associated with each container-item pair;
receiving a second image from the client device, wherein the second image depicts a subset of the plurality of physical containers and a subset of the plurality of visible contained items;
applying the contained-item identification model to the second image to identify the subset of the plurality of physical containers and the subset of the plurality of visible contained items depicted in the second image;
generating a second set of container-item pairs, wherein each of the second set of container-item pairs comprises an identified container of the subset of the physical containers of the second image and the visible contained items contained by the corresponding containers;
identifying an order of the plurality of orders associated with the second image;
identifying a container of the subset of the plurality of physical containers depicted in the second image that is not associated with the identified order of the plurality of orders;
identifying that a sorting error occurred based on the identified container; and
transmitting an alert to the client device, wherein the alert causes the client device to display an instruction to a user associated with the client device to correct the sorting error.

20. The system of claim 19, wherein the contained-item identification model is trained to output at least one of bounding boxes indicating where physical containers are located in an image, identifiers for visible contained items depicted in an image, or bounding boxes for visible contained items depicted in an image.
